(19) United States
(12) Patent Application Publication
(10) Pub. No.: US 2007/0193430 A1
(43) Pub. Date: Aug. 23, 2007

(54) Restringing device for stringed musical instruments

(76) Inventor: Jin Tae Jang, Maywood, NJ (US)

Correspondence Address: PARK LAW FIRM, 3255 WILSHIRE BLVD, SUITE 1110, LOS ANGELES, CA, 90010, US

(21) Appl. No.: 11/359,829

(22) Filed: Feb. 22, 2006

(51) Int. Cl. G10D 3/00

(52) U.S. Cl. 84/313

(57) ABSTRACT

A restringing device for a stringed musical instrument includes an elongated housing including a first end and a second end, a driving shaft rotatably attached to the first end, a tuning socket that receives a tuning peg of the instrument and engages with the driving shaft, a string cutter that cuts excess length of a string for the instrument, and a bridge pin puller that pulls out a bridge pin of the instrument. The rotating speed and the torque of the driving shaft are adjustable, and the rotation direction of the driving shaft is selectable. Various sizes and shapes of tuning sockets are provided and engage with the driving socket interchangeably. The rotation speed of the driving shaft is controllable in a fast winding mode and a fine tuning mode. The driving shaft stops when the tension of a string that is restringed reaches a threshold.

### BACKGROUND OF THE INVENTION

The present invention relates to a restringing device for stringed musical instrument. More particularly, this invention relates to a restringing device, which can perform tensioning of strings, cutting of the strings and pulling out bridge pins effectively and by itself.

Strings of most musical instruments need to be replaced when damaged or worn out. It is also known that strings are regularly replaced for its optimal performance. However, replacing the strings is not an easy task.

It is because tuning pegs of theses instruments have plural gears installed. These gears fight against tension of the strings and, therefore, help the user to tune with relatively small effort. These gears also prevent loosening of the strings and allow more precision tuning. On the other hand, because of the gear ratio (1/15+), the user has to wind the peg many times. This is very time and effort consuming, inflicts stress on fingers and wrist of the musician. Moreover, it sometimes causes more serious harm such as carpal tunnel syndrome. It is painful work for all stringed instrument musicians for the above reasons.

Also musicians commonly need two or more tools to replace strings. Besides leading to wind and unwind strings, a cutting tool is needed to cut off the excess strings. Most replacement strings are made longer than necessary length in order to be available for variety of instruments. For the above reasons, cutting tools (such as clipper and nipper) are used to cut excess strings according to size of the instrument.

But above tools wear out easily when used for thick strings (such as bass strings, lower strings) and sometimes require extra tools.

In addition, instruments, such as acoustic guitars, use bridge pins to hold down strings. These pins need to be removed every time the strings need to be replaced, but the pins are so firmly placed that it cannot be removed with bare hands but need yet another tool (such as pliers, nippers etc). But such tools may damage expensive musical instruments and bridge pins of high-quality material (ivory, ebony etc).

It is very inconvenient and ineffective to carry all the necessary tools.

Many tools were developed by prior art in order to solve these problems.

U.S. Pat. Nos. 5,505,116, 6,255,575, and 5,272,953 disclose manual string winders. These tools use an attached handle to manually wind pegs. It lessened the stress of winding the peg, but still required lots of work and was not a significant improvement. Also, since the axis, about which rotation of the handle occurs, is not fixed, the handle may move laterally thereby decreasing efficiency.

Following the manual winder, a motorized restring tools were invented. In 1974, APPARATUS FOR ADJUSTING THE TENSION OF AN ELONGATED STRETCHED FILAMENT (U.S. Pat. No. 3,813,983) was introduced and similar items soon followed (U.S. Pat. Nos. 4,791,849, 6,294,719, D412, 011, 4,791,849, 5,410,939, 4,889,029). The function of tools disclosed in U.S. Pat. Nos. 4,791,849 and 4,889,029 is directed to fine tuning of a string. These tools does not provide fast operation including rapid winding or unwinding. The function of tools disclosed in U.S. Pat. Nos. 3,813,983, D421,882, 6,294,719, D412,011, D342,001 and 5,410,939 is directed to winding and unwinding of a string. But these tools were only used to wind the strings and still required the user to carry extra tools for cutting and removing bridge pins.

Another disadvantage of the above-described motorized tools is that due to their fast speed and strong power, breaking of string may occur from over winding when a user is careless.

Among the tools that are already known, the manual string winder disclosed in U.S. Pat. Nos. 5,505,116 and 6,255,575 has the ability to cut strings but was not effective for thick strings (such as bass strings, lower strings) because it was very hard to cut and both hands had to be used.

U.S. Pat. No. 6,294,719 discloses a tool, which can be applied to many different types of pegs (acoustic guitar, electric guitar, bass guitar etc). But this is relatively too big for some instruments, which have narrow space between pegs (such as 12 strings guitar, banjo, mandolin, etc). Actually, this size of tuning socket interferes with surrounding tuning pegs.

A multi-function restringing tool that can effectively perform the various tasks for changing and restringing strings for stringed musical instruments has long been in need.

### SUMMARY OF THE INVENTION

The present invention contrives to solve the disadvantages of the prior art.

An objective of the invention is to provide a restringing device for stringed musical instrument, which can perform tensioning of strings, cutting of the strings and pulling out bridge pins without requiring separate tools.

Another objective of the invention is to provide a restringing device for stringed musical instrument, which utilizes motorized turning of pegs, and controlled turning of pegs according to the tension of a string that is wound by the device.

Still another objective of the invention is to provide a restringing device for stringed musical instrument, which minimizes motion path for performing the tensioning of strings-and cutting of the strings.

In order to achieve the above objectives, the present invention provides a restringing device for a stringed musical instrument. The restringing device includes an elongated housing including a first end and a second end, a driving shaft rotatably attached to the first end of the housing, a tuning socket that is adapted to receive a tuning peg of the stringed musical instrument, a string cutter that is adapted to cut excess length of a string for the stringed musical instrument, a bridge pin puller that is adapted to pull out a bridge pin of the stringed musical instrument, and an illuminating light, which is provided near the first end of the housing.

The rotating speed and the torque of the driving shaft are adjustable. The rotation direction of the driving shaft is selectable. The tuning socket engages with the driving shaft.

The string cutter is provided at the second end of the housing.

The bridge pin puller is provided at the second end of the housing, and the bridge pin puller includes an open bridge pin slot that is adapted to hold the bridge pin.

The rotation speed of the driving shaft is controllable in a fast winding mode and a fine tuning mode. The rotation speed of the driving shaft in the fast winding mode is faster than the rotation speed of the driving shaft in the fine tuning mode.

The rotation speed of the driving shaft changes from the fast winding mode to the fine tuning mode when the tension of a string reaches a threshold for the string.

Alternatively, the rotation the driving shaft stops when the tension of a string reaches a threshold for the string.

The restringing device is adapted to receive information of vibration frequency of the string from the stringed musical instrument.

Alternatively, the device is adapted to receive information of vibration frequency of the string from a microphone. Preferably, the microphone is a built-in microphone.

The string cutter includes a cutter handle, a moving cutter blade, and a fixed cutter blade. The moving cutter blade is pivoted toward the fixed cutter blade by the cutter handle.

The string cutter further includes a cutter release button and a spring coil. The spring coil presses the cutter handle outward from the housing and the cutter handle in turn pivots the moving cutter blade away from the fixed cutter blade. When the cutter release button is pushed, the cutter handle is pivoted outward from the housing by the spring coil.

The tuning socket includes a peg receiver and a connecting part that protrudes from the peg receiver, and a driving shaft receiving recess that is adapted to receive the driving shaft, and is provided in the connecting part.

The peg receiver includes a peg receiving recess that is open in the direction opposite to the direction that the connecting part protrudes.

The peg receiver further includes a first wall and a second wall, two side walls that connect the first wall and the second wall, and a base from which the first wall, the second wall and the side walls extend. An oversize peg guide slot is formed on each of the side walls.

The base may include a round recess that has a substantially constant width.

The connecting part includes a magnet that is provided in the driving shaft receiving recess.

The restringing device further includes an audible alert device that generates an audible alert when the vibration frequency of a string approaches to a predetermined value. The contents of the audible alert are gradually changed as the vibration frequency approaches to or recedes from the predetermined value.

The restringing device further includes a visual alert device that generates a visual alert when the vibration frequency of a string approaches to a predetermined value. The contents of the visual alert are gradually changed as the vibration frequency approaches to or recedes from the predetermined value.

The advantages of the present invention are: (1) the restringing device of the present invention functions as a multi-function portable motorized electric device that can change strings for most stringed musical instruments; (2) the restringing device enables restringing effect working with least movement and effort; (3) the restringing device enables winding, unwinding, cutting, and pulling bridge pins with only one hand without changing the position of tool's grip or a user's pose; (4) sockets that engage with tuning pegs of instrument are designed to fit each different instrument perfectly allowing instruments with narrow pegs space like banjo, mandolin, guitar, and 12 strings guitar so that it would not get in the way of surrounding tuning pegs; (5) the restringing device uses inter-changeable sockets to use on different sizes of tuning pegs; (6) the inside of tuning socket is made with elastic material such as rubber plastics to prevent tuning peg's scratch; (7) the operation button is installed at the middle of the device to allow easier operation even when user holds it backward; (8) the restringing device prevents overwinding of a string.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing an advanced restringing device according to the present invention;

FIG. 2 is a perspective view of the advanced restringing device view from another direction;

FIG. 3 is a perspective view of the advanced restringing device view from still another direction;

FIG. 4 is a perspective view of a basic restringing device according to the present invention;

FIG. 5(a) is a plan view of the advanced restringing device;

FIG. 5(b) is a front elevation view of the advanced restringing device;

FIG. 5(c) is a side elevation view of the advanced restringing device;

FIG. 6(a) is a plan view of the basic restringing device;

FIG. 6(b) is a front elevation view of the basic restringing device;

FIG. 6(c) is a side elevation view of the basic restringing device;

FIG. 7 is a perspective view showing the operation of winding the tuning pegs of instrument with the advanced restringing device;

FIG. 8 is a perspective view showing the operation of winding the tuning pegs of instrument with the basic restringing device;

FIG. 9(a) is an elevation view showing a tuning peg of a guitar is engaged with a socket and rotated;

FIG. 9(b) is an elevation view showing the tuning peg of a guitar is aligned with the socket;

FIG. 10 is a perspective view showing a cutting operation of a string with the restringing device;

FIG. 11 is a perspective view showing a cutting operation of a string with the restringing device viewed from a different direction;

FIGS. 12(a), 12(b) and 12(c) are elevation views showing steps of the cutting operation;

FIGS. 12(d), 12(e) and 12(f) are partial enlarged views showing steps of the cutting operation;

FIG. 13 is an elevation view showing the cutter and related parts;

FIG. 14 is a perspective view showing a removing operation of a bridge pin of a guitar with the advanced restringing device;

FIG. 15 is a perspective view showing a removing operation of a bridge pin of a guitar with the basic restringing device;

FIG. 16(a) is an elevation view showing the operation of a bridge pin puller;

FIG. 16(b) is a partial enlarged view showing the operation of the bridge pin puller;

FIG. 17(a) is an elevation view showing that a tuning socket is aligned with a driving shaft for replacement of the tuning socket;

FIG. 17(b) is a cross section view of the tuning socket;

FIG. 18 is a perspective view of the tuning socket;

FIG. 19(a) is a plan view of the tuning socket;

FIG. 19(b) is a side elevation view of the tuning socket;

FIG. 19(c) is a front elevation view of the tuning socket;

FIG. 19(d) is a cross section view of the tuning socket;

FIG. 19(e) is a bottom view of the tuning socket;

FIGS. 20(a), 20(b) and 20(c) are partial elevation views showing a tuning socket that accommodates various shapes of tuning pegs;

FIG. 21(a) is a plan view of a tuning socket for a base guitar;

FIG. 21(b) is a side elevation view of the tuning socket for a base guitar;

FIG. 21(c) is a front elevation view of the tuning socket for a base guitar;

FIG. 21(d) is a cross section view of the tuning socket for a base guitar;

FIG. 21(e) is a bottom view of the tuning socket for a base guitar;

FIGS. 22(a) and 22(b) are partial elevation views showing a tuning socket that accommodates various shapes of tuning pegs of base guitars; and

FIG. 23 is a block diagram showing electronic functions of the restringing device.

### DETAILED DESCRIPTION OF THE INVENTION

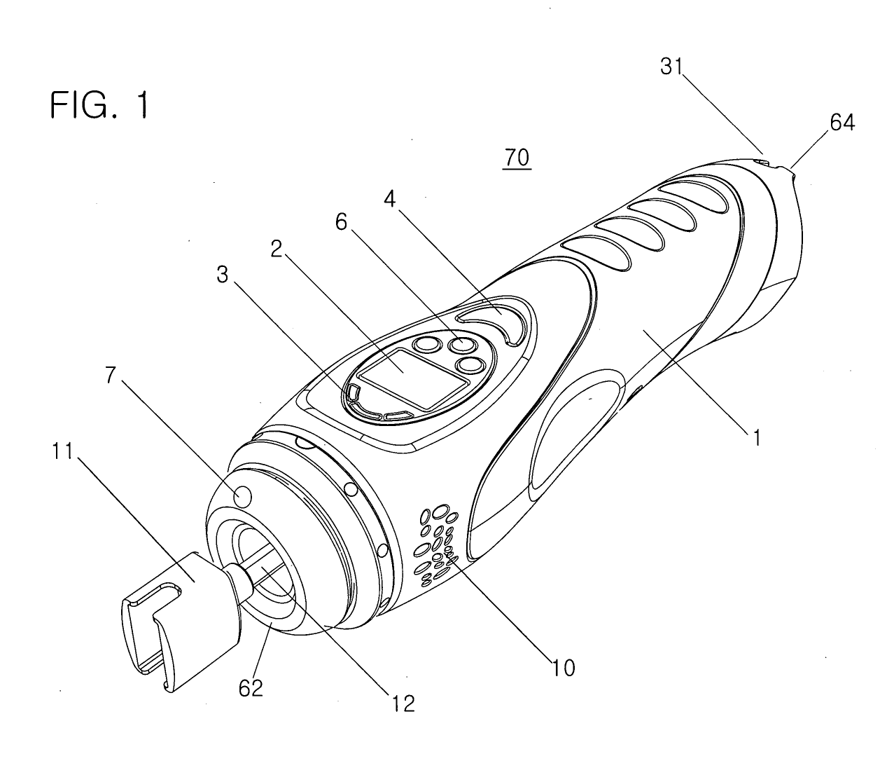

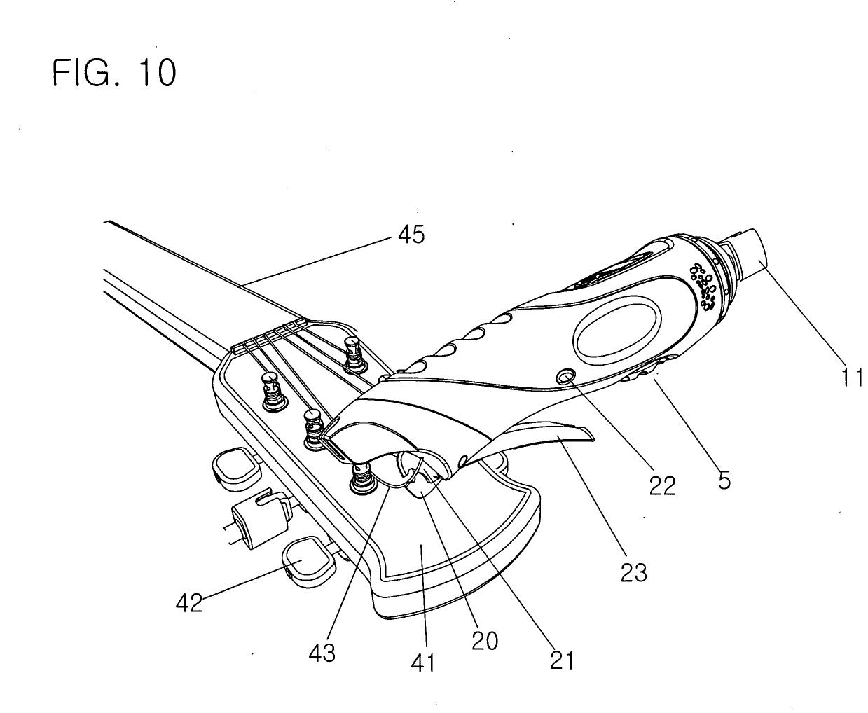

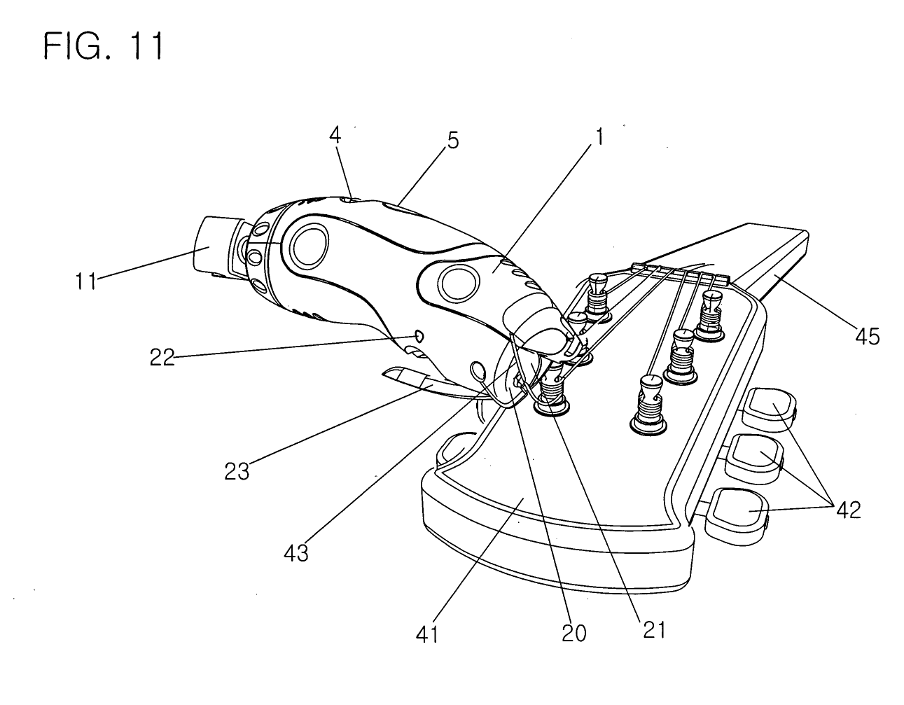

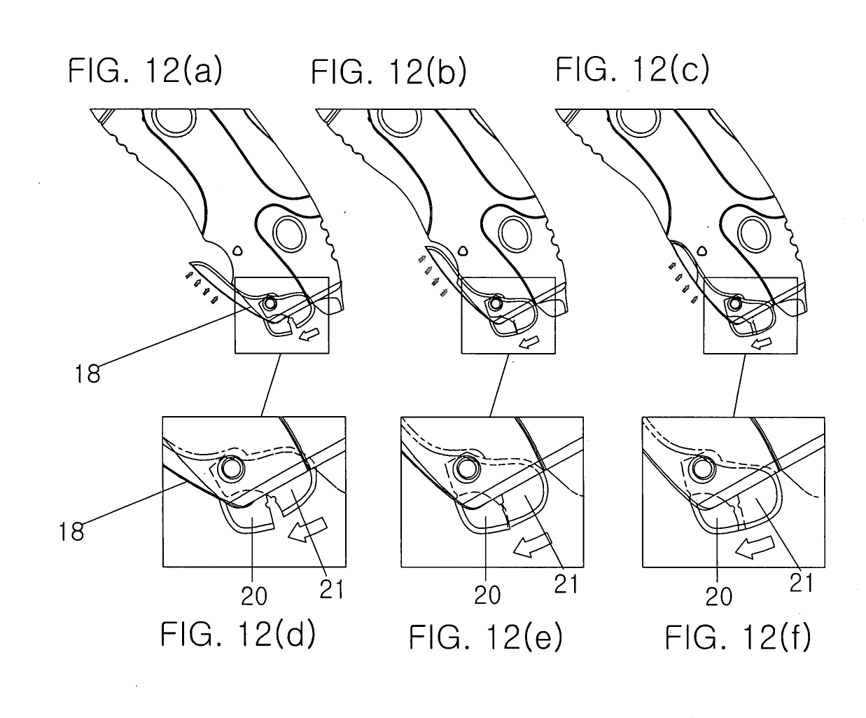

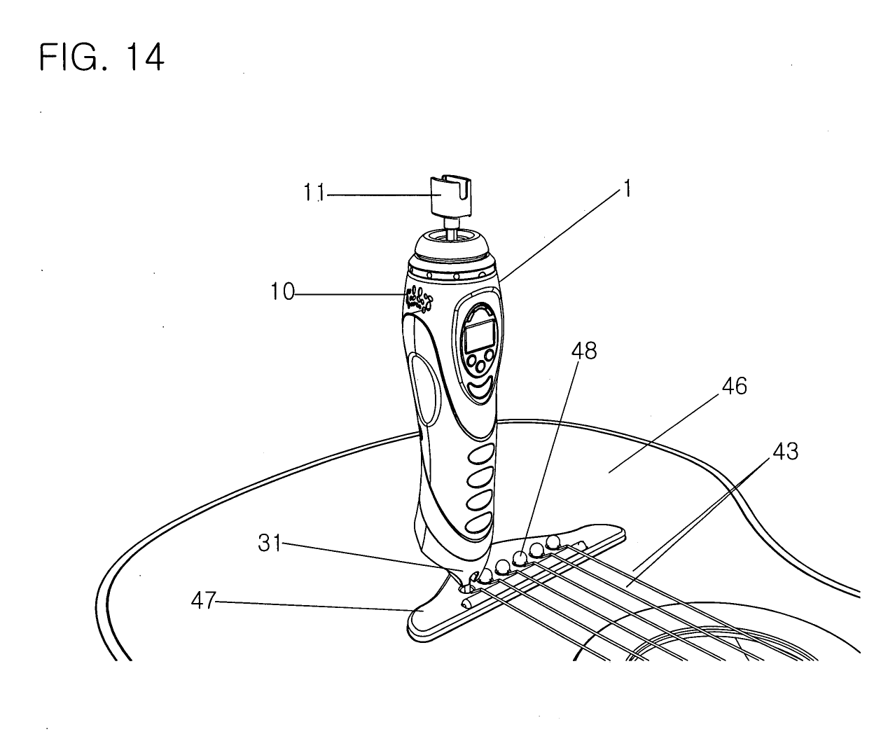

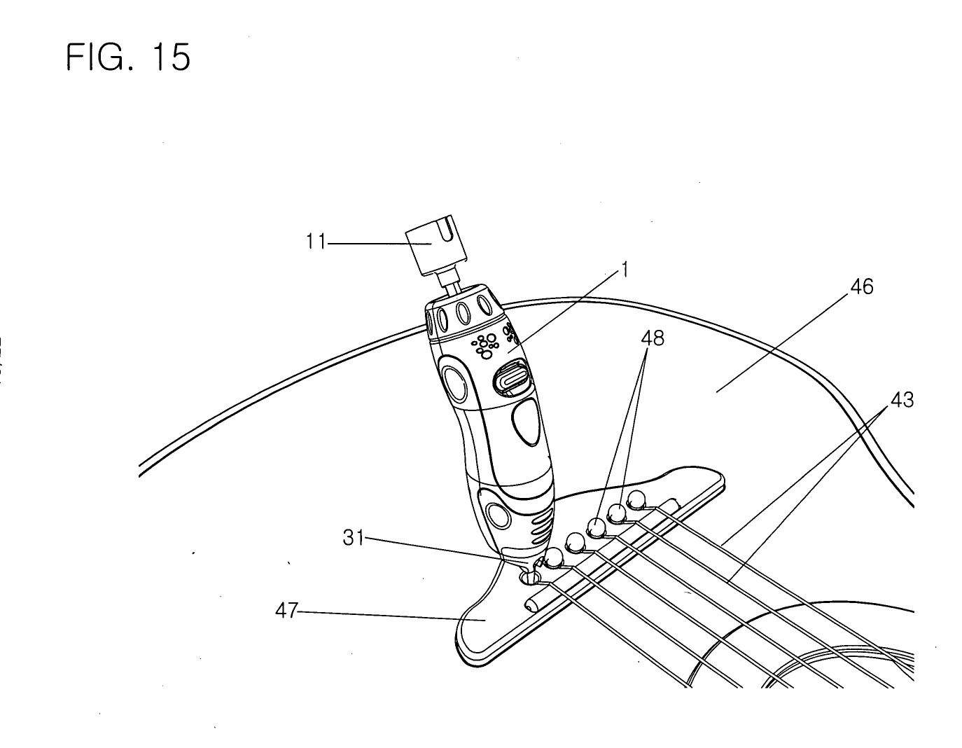

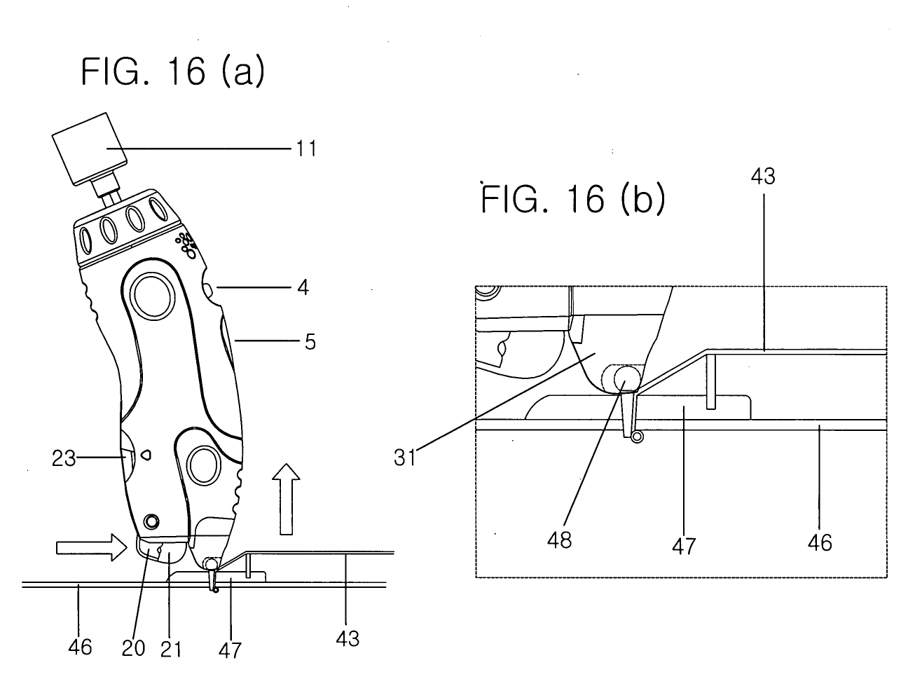

FIGS. 1-3 show a restringing device 70 for a stringed musical instrument. The restringing device 70 includes an elongated housing 1 including a first end 62 and a second end 64, a driving shaft 12 rotatably attached to the first end 62 of the housing 1, a tuning socket 11 that is adapted to receive a tuning peg 42 of the stringed musical instrument, a string cutter 18 that is adapted to cut excess length of a string 43 for the stringed musical instrument (refer to FIGS. 10-13), a bridge pin puller 31 that is adapted to pull out a bridge pin 48 of the stringed musical instrument (refer to FIGS. 14-16(b)), and an illuminating light 7, which is provided near the first end 62 of the housing 1. With the aid of the illuminating light 7, a string can be replaced even in dark places such as during concerts and dark performing stage.

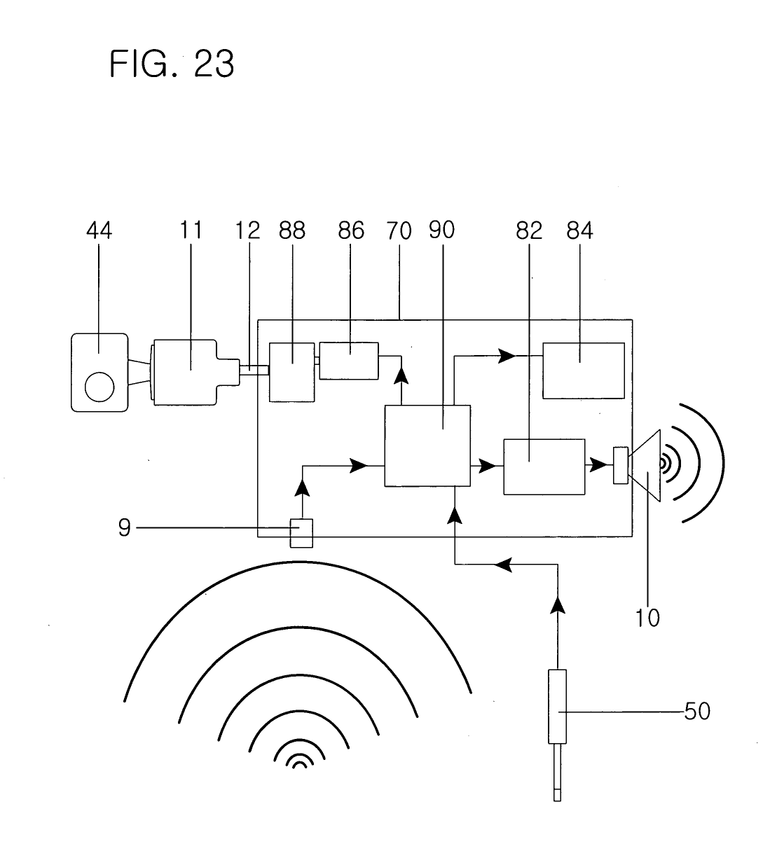

The rotating speed and the torque of the driving shaft 12 are adjustable. The rotation direction of the driving shaft 12 is selectable. The tuning socket 11 engages with the driving shaft 12. A motor 86 and gear train 88 are enclosed inside the housing 1 to rotate the driving shaft 12 in both directions (refer to FIG. 23). In this way, stress on hands and wrists are decreased while making the restringing process more convenient. The motor and other elements of the restringing device 70 is battery-powered and also may be powered from external power resource (such as AC-DC adaptor) in case of low or no battery.

Referring to FIG. 1, on the outside of the housing 1 are installed an LCD screen 2, which shows the operation details of the restringing device 70, an LED tuning guide light 3, which shows operation status of the restringing device 70, a direction selector 4, an operation switch 5 that starts or stops the driving shaft 12, and a function switch 6 which selects an instrument and a particular string to be restringed, and other advanced functions of the restringing device 70.

The operation switch 5 is positioned around the middle of the housing 1. In this way, the operation of the restringing device 70 is facilitated when a user grips the device in the opposite direction.

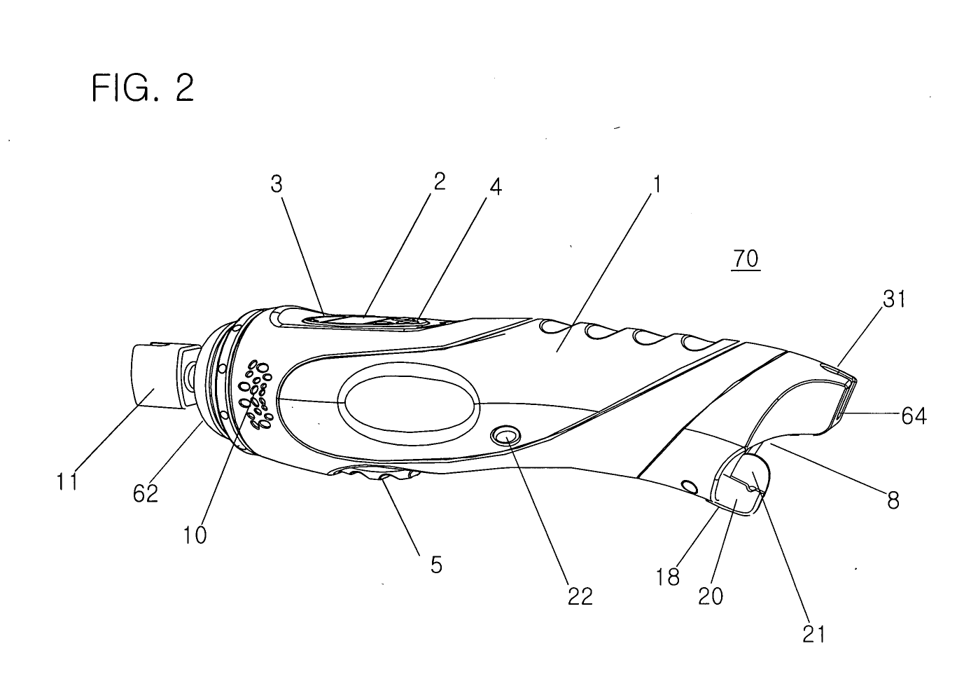

Referring to FIG. 2, the string cutter 18 is provided at the second end 64 of the housing 1.

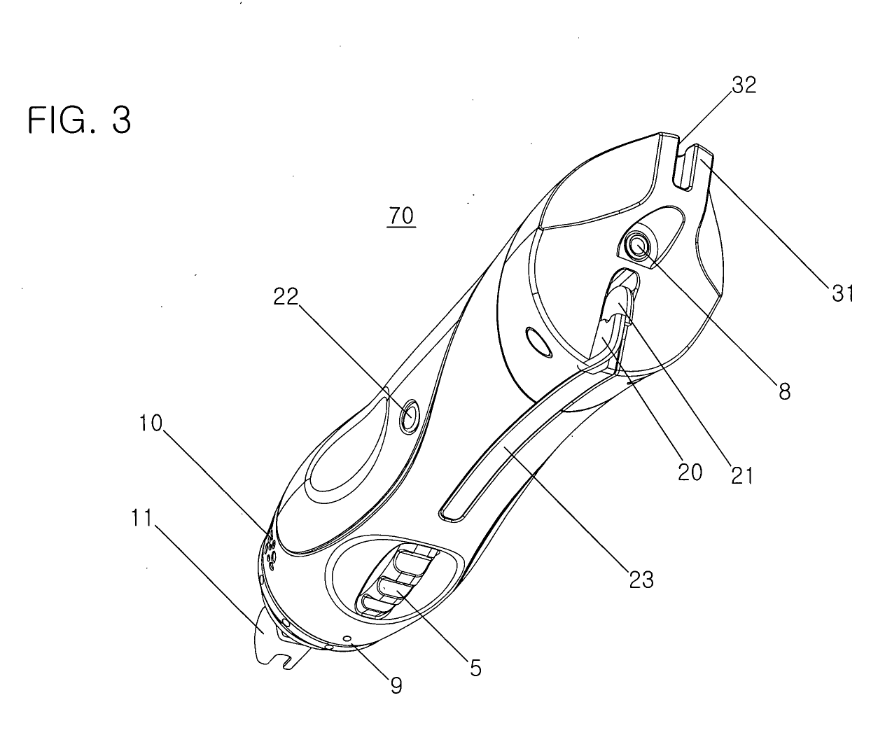

Referring to FIG. 3, the bridge pin puller 31 is provided at the second end 64 of the housing 1, and the bridge pin puller 31 includes an open bridge pin slot 32 that is adapted to hold the bridge pin 48.

The position of the string cutter 18 and the bridge pin puller 31 enables a user to cut strings or remove bridge pins or wind strings without changing position or grip.

The rotation speed of the driving shaft 12 is controllable in a fast winding mode and a fine tuning mode. The rotation speed of the driving shaft 12 in the fast winding mode is faster than the rotation speed of the driving shaft 12 in the fine tuning mode.

The rotation speed of the driving shaft 12 changes from the fast winding mode to the fine tuning mode when the tension of the string 43 reaches a threshold for the string 43. The threshold is predetermined for a given string 43 and is stored in or input to the stringing device 70. In this way, the fast winding mode is used for winding the string quickly to the point at which the string 43 has a tension, which is approximate to but slight less than the precise tension for the string 43. Fine tuning mode is used to fine-tune the string 43 until the string 43 has the precise tension, or vibration frequency.

Alternatively, the rotation the driving shaft 12 stops when the tension of a string 43 reaches a threshold for the string 43. In this way, the restringing device 70 prevents overwinding of the string 43. Therefore excess tension, or break of the string 43 is prevented.

The restringing device 70 is adapted to receive information of vibration frequency of the string 43 from the stringed musical instrument.

Alternatively, the restringing device 70 is adapted to receive information of vibration frequency of the string 43 from a built-in microphone 9 (refer to FIG. 3). The built-in microphone 9 is useful for tuning acoustic guitars.

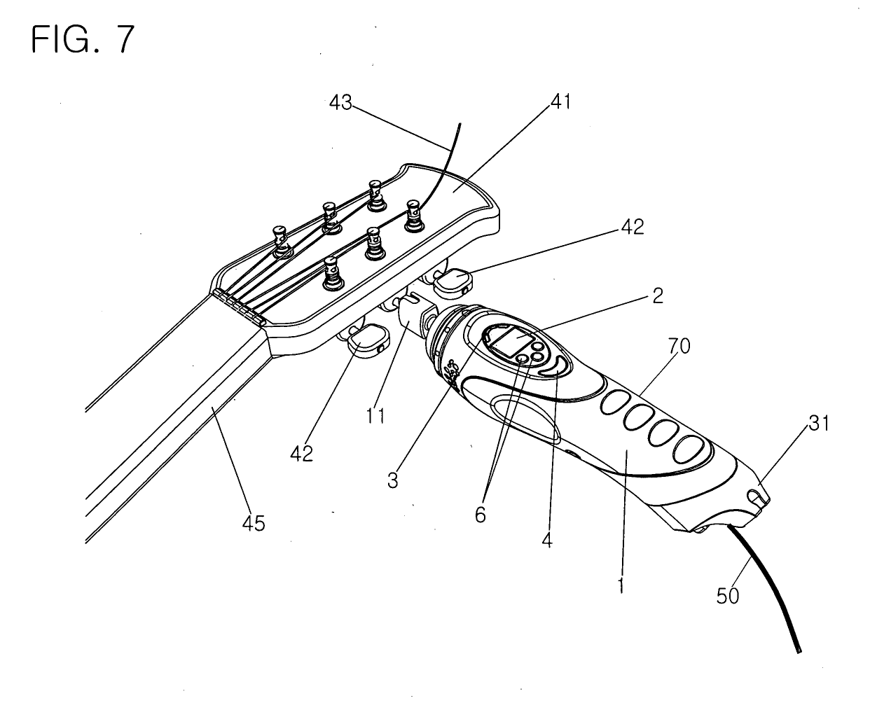

When a user intends to use this automatic stop function, the user sets the restringing device 70 into an automatic stop mode, and selects a string to be restringed. When the user play or pluck the string, an electronic circuit inside the restringing device 70 senses the vibration of the string and starts the motor to wind the string. The vibration is sensed by receiving signal from the instrument via a connector cable 50 (refer to FIG. 7) that is connected with an instrument connecting jack 8 (refer to FIG. 3), or through the use of the built-in microphone 9. The winding may also be started by pushing the operation switch 5. The electronic circuit cuts electric power to the motor when the vibration of the string reaches the threshold.

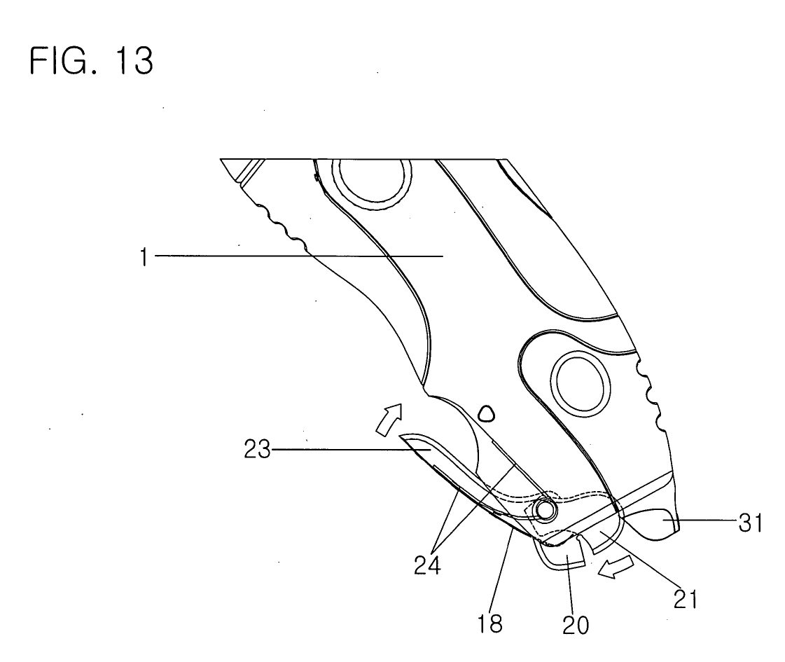

FIG. 13 shows that the string cutter 18 includes a cutter handle 23, a moving cutter blade 21, and a fixed cutter blade 20. The string cutter 18 is provided to remove excess length of the string that is replaced with an old string. The moving cutter blade 21 is pivoted toward the fixed cutter blade 20 by the cutter handle 23.

The string cutter 18 further includes a cutter release button 22 and a spring coil 24. The spring coil 24 presses the cutter handle 23 outward from the housing 1 and the cutter handle 23 in turn pivots the moving cutter blade 21 away from the fixed cutter blade 20. When the cutter release button 22 is pushed, the cutter handle 23 is pivoted outward from the housing 1 by the spring coil 24. The spring coil 24 also returns the cutter handle 23 when a user releases the cutter handle 23 after cutting a string.

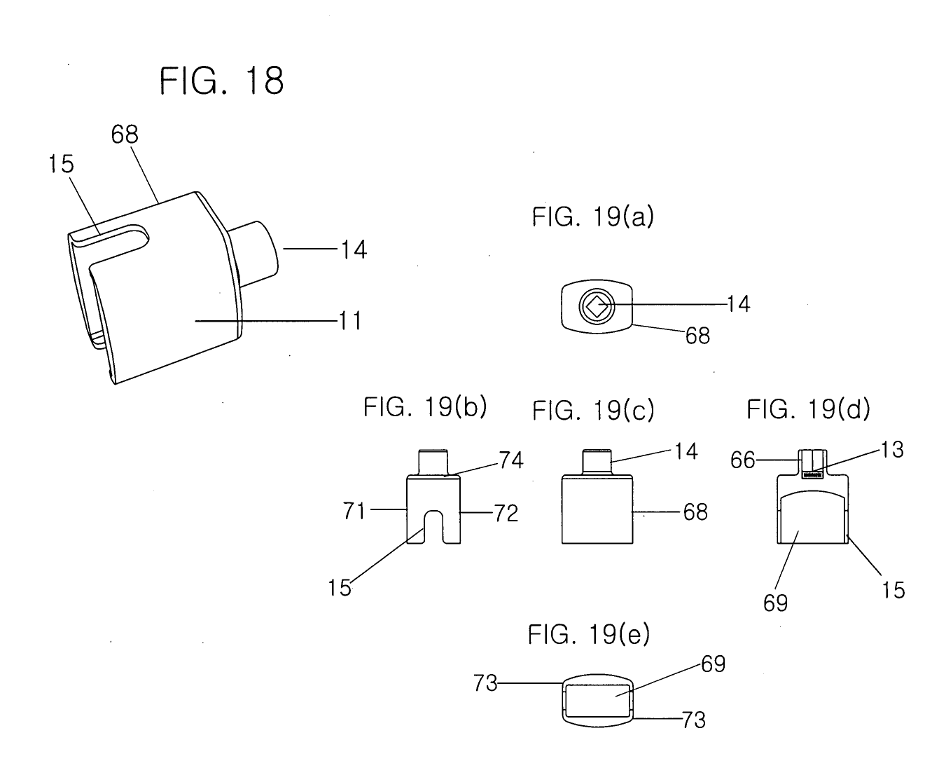

FIGS. 18 and 19(a)-19(e) show the tuning socket 11 in detail. The tuning socket 11 includes a peg receiver 68 and a connecting part 14 that protrudes from the peg receiver 68, and a driving shaft receiving recess 66 that is adapted to receive the driving shaft 12, and is provided in the connecting part 14. The connecting part 14 includes a magnet 13 that is provided in the driving shaft receiving recess 66. The magnet 13 keeps the tuning socket 11 engaged with the driving shaft 12.

The peg receiver 68 includes a peg receiving recess 69 that is open in the direction opposite to the direction that the connecting part 14 protrudes.

The peg receiver 68 further includes a first wall 71 and a second wall 72, two side walls 73 that connect the first wall 71 and the second wall 72, and a base 74 from which the first wall 71, the second wall 72 and the side walls 73 extend. An oversize peg guide slot 15 is formed on each of the side walls 73. The oversize peg guide slots 15 are useful to hold a large peg.

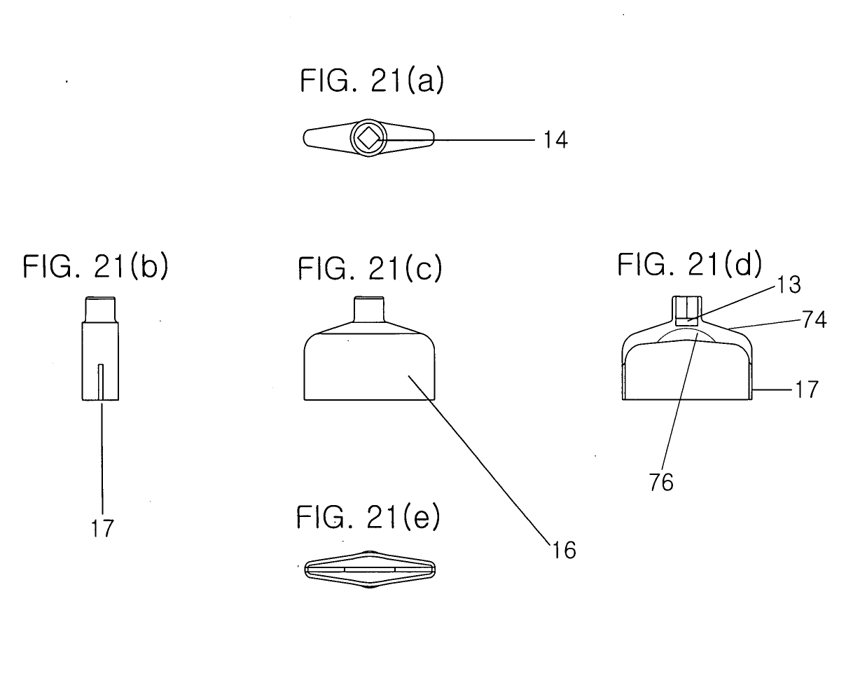

FIGS. 21(a)-21(e) show a relatively thin tuning socket 16, which is suitable for holding a peg of a base guitar and a vintage guitar. The base 74 includes a round recess 76 that has a substantially constant width. The round recess 76 is used to hold a thin tip of a peg. The tuning socket 16 is suitable for banjos, mandolins, 12 strings guitars, for which the distance between pegs is narrow. The tuning socket 16 has vintage peg guides 17, which are narrow slots provided in the side walls of the tuning socket 16.

The tuning socket 11 is provide in various shapes as explained above, and a tuning socket that is particularly suitable for an instrument to be restringed may be selected and used, and replaced when a user wants to restring a different instrument that has many different size and types of peg.

FIG. 23 shows electric and electronic operation of the restringing device 70. The restringing device 70 includes a control module 90, an audible alert device 82 and a visual alert device 84. The control module 90 controls the speed, direction and torque of the motor 86. The control module 90 also receives information from the built in microphone 9, via the connector cable 50 and the instrument connecting jack 8, or function switch 6, etc, stores the information and uses the information for various functions including control of the audible alert device 82 and the visual alert device 84.

The audible alert device 82 generates an audible alert when the vibration frequency of the string 43 approaches to a predetermined value for the string 43. The audible alert is given with a built-in speaker 10 (refer to FIG. 1). The contents of the audible alert is gradually changed as the vibration frequency approaches to or recedes from the predetermined value. The contents may be tone, amplitude or frequency of the audible alert.

The visual alert device 84 generates a visual alert when the vibration frequency of a string approaches to a predetermined value. The contents of the visual alert is gradually changed as the vibration frequency approaches to or recedes from the predetermined value. The contents may be light intensity or blinking frequency of the tuning guide light 3, or numbers or symbols that are displayed on the screen 2.

The user may effectively use the audio or video alerts in fine and precise tuning of musical instruments.

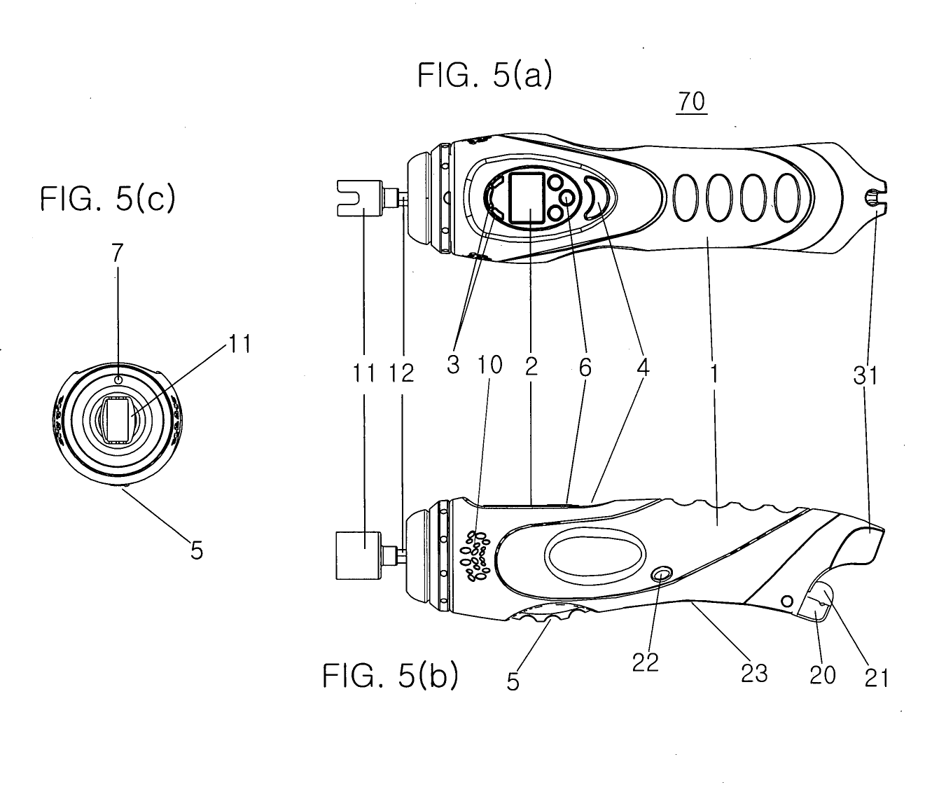

Referring back to the drawings, FIGS. 1-3, and 5(a)-5(c) show the restringing device 70 in general. The restringing device has the advanced function of overwinding prevention.

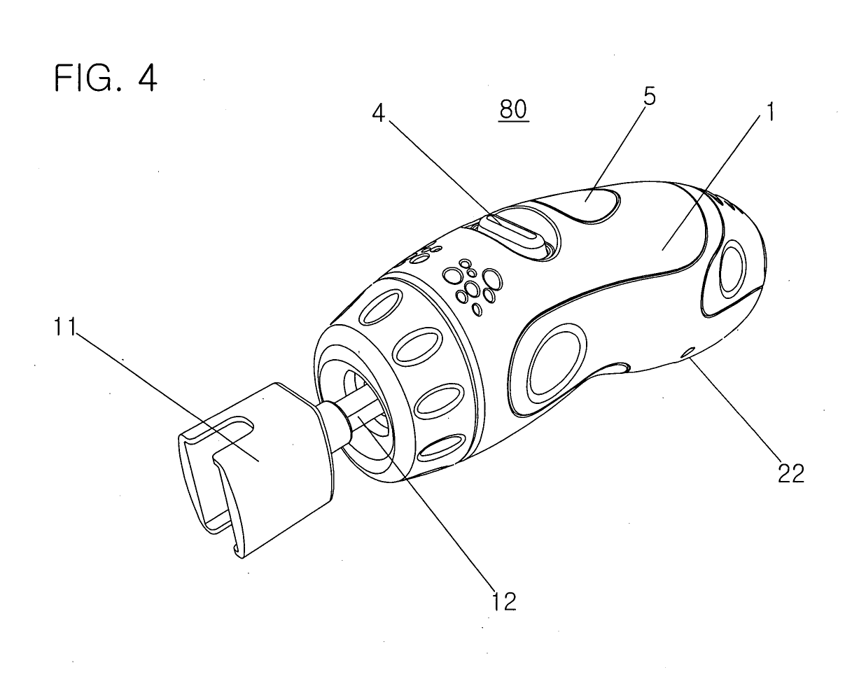

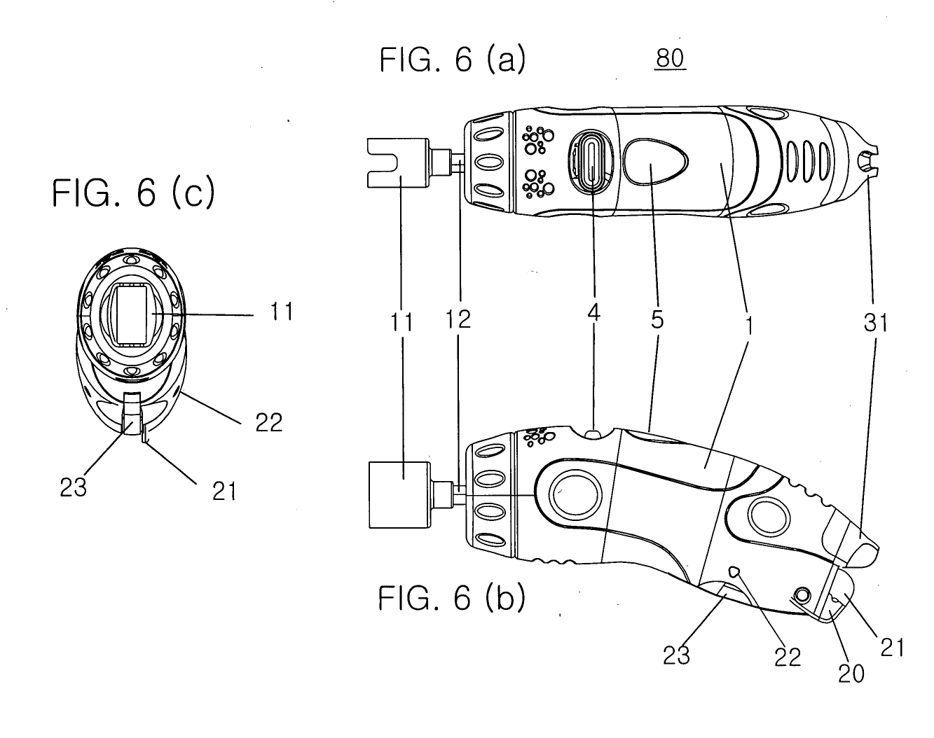

FIGS. 4 and 6(a)-6(c) show a basic restringing device 80 which does not have the overwinding prevention function.

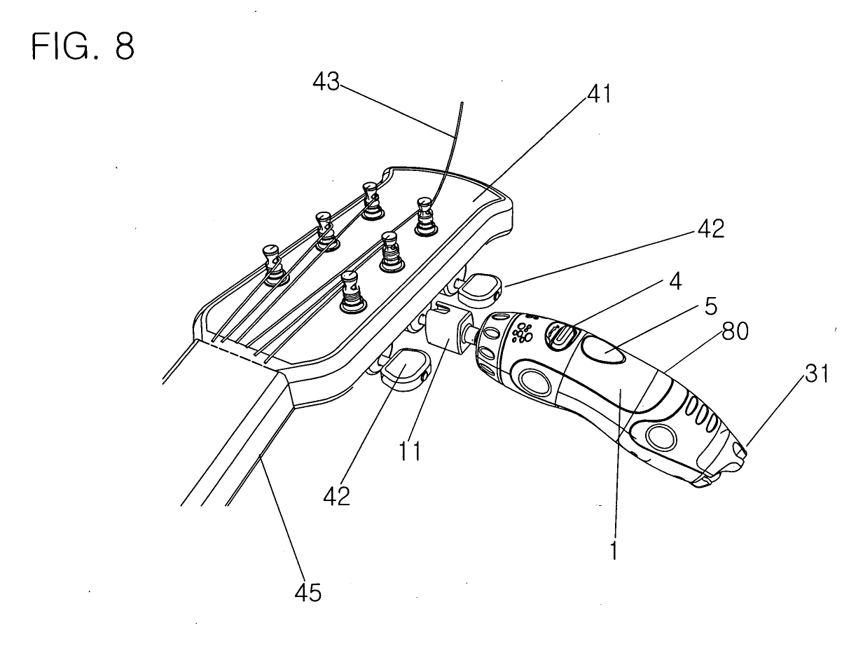

FIGS. 7 and 8 show the operation of winding the tuning pegs 42 that are provided on a guitar head 41, which is connected to a guitar neck 45.

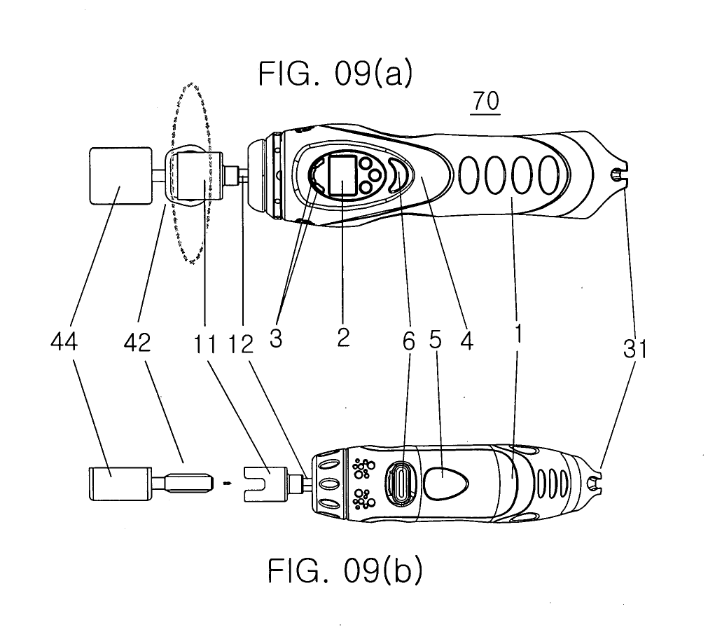

FIGS. 9(a) and 9(b) showing the tuning peg 42, which is connected to a tuning gear 44, is engaged with the tuning socket 11 and rotated.

FIGS. 10-13 show cutting operation of the string with the restringing device 70, 80.

FIGS. 14-16(b) show removing operation of the bridge pin 48 that is inserted in the bridge 47 which is provided on a guitar body 46.

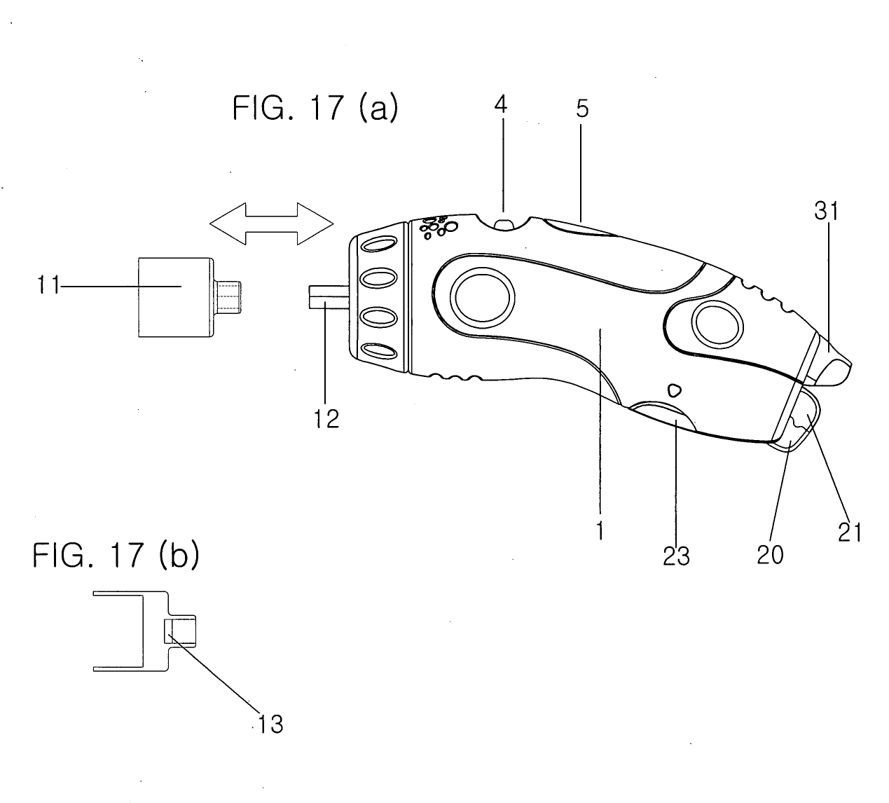

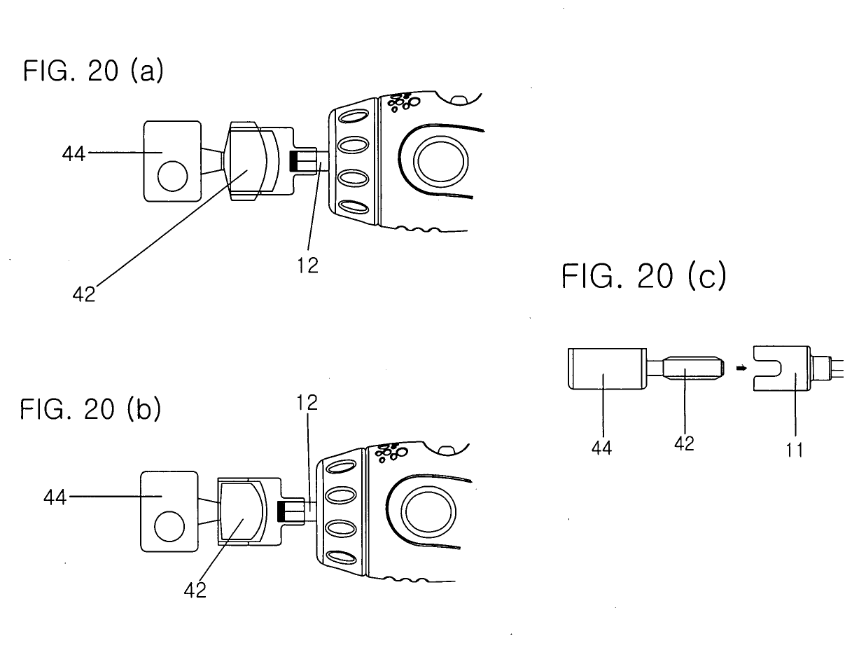

FIGS. 17(a)-20(c) show the details of the tuning socket 11 and how the tuning socket 11 is used.

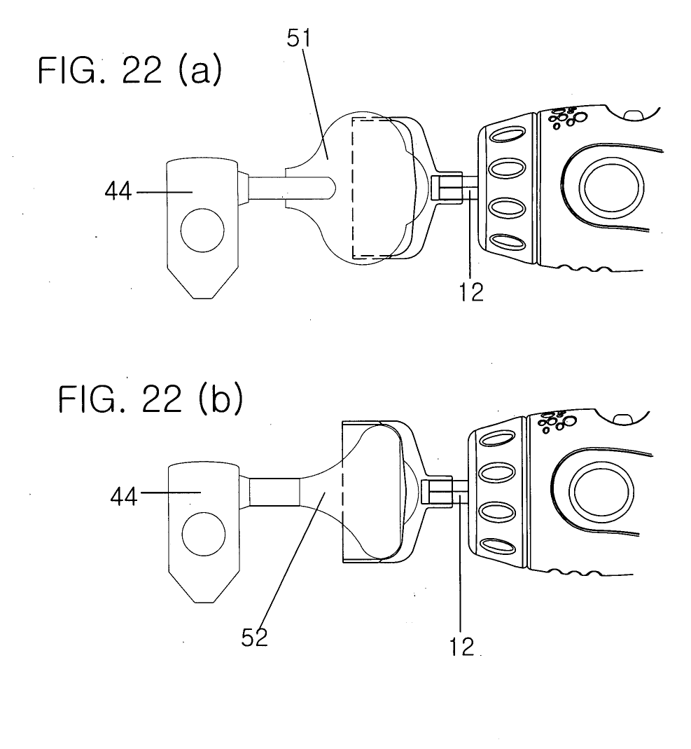

FIGS. 21(a)-22(b) show the details of the tuning socket 16 and how the tuning socket 16 is used for various shapes and sizes of tuning pegs such as a large guitar tuning peg 51 and a small guitar tuning peg 52.

FIG. 23 shows components related to the electric and electronic operations of the restringing device 70.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A restringing device for a stringed musical instrument comprising:
a) an elongated housing comprising a first end and a second end;
b) a driving shaft rotatably attached to the first end of the housing;
c) a tuning socket that is adapted to receive a tuning peg of the stringed musical instrument;
d) a string cutter that is adapted to cut excess length of a string for the stringed musical instrument;
wherein the rotating speed and the torque of the driving shaft are adjustable, wherein the rotation direction of the driving shaft is selectable, wherein the tuning socket engages with the driving shaft.

2. The device of claim 1, wherein the string cutter is provided at the second end of the housing.

3. The device of claim 1, further comprising a bridge pin puller that is adapted to pull out a bridge pin of the stringed musical instrument.

4. The device of claim 3, wherein the bridge pin puller is provided at the second end of the housing, and the bridge pin puller comprises an open bridge pin slot that is adapted to hold the bridge pin.

5. The device of claim 1, wherein the rotation speed of the driving shaft is controllable in a fast winding mode and a fine tuning mode, wherein the rotation speed of the driving shaft in the fast winding mode is faster than the rotation speed of the driving shaft in the fine tuning mode.

6. The device of claim 5, wherein the rotation speed of the driving shaft changes from the fast winding mode to the fine tuning mode when the tension of a string reaches a threshold for the string.

7. The device of claim 5, wherein the rotation the driving shaft stops when the tension of a string reaches a threshold for the string.

8. The device of claim 5, wherein the device is adapted to receive information of vibration frequency of the string from the stringed musical instrument.

9. The device of claim 5, wherein the device is adapted to receive information of vibration frequency of the string from a microphone.

10. The device of claim 9, wherein the microphone comprises a built-in microphone.

11. The device of claim 1, further comprising an illuminating light, which is provided near the first end of the housing.

12. The device of claim 1, wherein the string cutter comprises a cutter handle, a moving cutter blade, and a fixed cutter blade, wherein moving cutter blade is pivoted toward the fixed cutter blade by the cutter handle.

13. The device of claim 12, wherein the string cutter further comprises a cutter release button and a spring coil, wherein the spring coil presses the cutter handle outward from the housing and the cutter handle in turn pivots the moving cutter blade away from the fixed cutter blade, wherein when the cutter release button is pushed, the cutter handle is pivoted outward from the housing by the spring coil.

14. The device of claim 1, wherein the tuning socket comprises a peg receiver and a connecting part that protrudes from the peg receiver, and a driving shaft receiving recess that is adapted to receive the driving shaft, and is provided in the connecting part.

15. The device of claim 14, wherein the peg receiver comprises a peg receiving recess that is open in the direction opposite to the direction that the connecting part protrudes.

16. The device of claim 15, wherein the peg receiver further comprises a first wall and a second wall, two side walls that connect the first wall and the second wall, and a base from which the first wall, the second wall and the side walls extend, wherein a oversize peg guide slot is formed on each of the side walls.

17. The device of claim 16, wherein the base comprises a round recess that has a substantially constant width.

18. The device of claim 15, wherein the connecting part comprises a magnet that is provided in the driving shaft receiving recess.

19. The device of claim 1, further comprising an audible alert device that generates an audible alert when the vibration frequency of a string approaches to a predetermined value, wherein the contents of the audible alert is gradually changed as the vibration frequency approaches to or recedes from the predetermined value.

20. The device of claim 1, further comprising a visual alert device that generates an visual alert when the vibration frequency of a string approaches to a predetermined value, wherein the contents of the visual alert is gradually changed as the vibration frequency approaches to or recedes from the predetermined value.
